(19) United States
(12) Patent Application Publication
(10) Pub. No.: US 2026/0241608 A1
(43) Pub. Date: Aug. 20, 2026

(54) EJECTION DEVICE, MOLDING DEVICE, AND EJECTION METHOD

(71) Applicant: KYOCERA CORPORATION, Kyoto (JP)

(72) Inventors: Yoshimasa MIZUNO, Kyoto (JP); Tomoki BESSHO, Kyoto (JP)

(21) Appl. No.: 18/995,151

(22) PCT Filed: Aug. 3, 2022
(86) PCT No.: PCT/JP2022/029783

§ 371 Date: Jan. 16, 2025

(51) Int. Cl. B28B 13/02; B28B 7/00

(52) U.S. Cl. CPC B28B 13/0275; B28B 7/0032

(57) ABSTRACT

To provide an ejection device having an increased ejection amount per unit time of a material having fluidity. The ejection device includes:
a filling portion including a first space and a second space that are filled with a material; an ejection portion including an ejection path configured to communicate with the first space or the second space; and
a switching portion including a communication path through which the first end of the ejection path communicates with the first space or the second space, wherein the switching portion switches between a first state where, through the communication path, the first space communicates with the ejection path, and a second state where, through the communication path, the second space communicates with the ejection path.

### TECHNICAL FIELD

The present disclosure relates to an ejection device for ejecting a material having fluidity, a molding device including the ejection device, and an ejection method.

### BACKGROUND OF INVENTION

Patent Document 1 discloses a method and device for extrusion molding of a slurry. In the method, a foamed lightweight cement slurry filled in a magazine is supplied to an inlet of an extrusion molding device and is extruded with a piston.

### CITATION LIST

### Patent Literature

Patent Document 1: JP 02-14106 A

### SUMMARY

In one aspect of the present disclosure, an ejection device includes:
a filling portion including a first space and a second space, wherein the first space and the second space are filled with a material having a dispersion medium and a particulate dispersoid dispersed in the dispersion medium;
an ejection portion including an ejection path, wherein the ejection path includes a first end and a second end, the first end communicates with the first space or the second space, and the second end is open to outside; and
a switching portion including at least one communication path through which the first end of the ejection path communicates with the first space or the second space, wherein the switching portion switches between a first state where, through the at least one communication path, the first space communicates with the ejection path, and a second state where, through the at least one communication path, the second space communicates with the ejection path.

In one aspect of the present disclosure, an ejection method is an ejection method for a material using an ejection device. The ejection device includes:
a filling portion including a first space and a second space, wherein the first space and the second space are filled with the material having a dispersion medium and a particulate dispersoid dispersed in the dispersion medium;
an ejection portion including an ejection path, wherein the ejection path includes a first end and a second end, the first end communicates with the first space or the second space, and the second end is open to outside; and
a switching portion including at least one communication path through which the first end of the ejection path communicates with the first space or the second space, wherein the switching portion switches between a first state where, through the at least one communication path, the first space communicates with the ejection path, and a second state where, through the at least one communication path, the second space communicates with the ejection path.

The ejection method includes:
a first extrusion step of extruding the material filled in the first space out of the first space;
a second extrusion step of extruding the material filled in the second space out of the second space; and
a switching step of switching between the first state and the second state by the switching portion.

### BRIEF DESCRIPTION OF THE DRAWINGS

FIG. 1 is a perspective view illustrating a configuration of a molding device according to a first embodiment.

FIG. 2 is a cross-sectional view illustrating an example of a configuration of an ejection device according to the first embodiment.

FIG. 3 is a cross-sectional view illustrating a structure of a first piston.

FIG. 4 is a cross-sectional view for describing an example of dimensions of a first space and a communication path in an ejection device according to the first embodiment.

FIG. 5 is a diagram illustrating an example of an operation of the ejection device according to the first embodiment to eject a material.

FIG. 6 is a flowchart illustrating an example of an ejection method for a material by the ejection device according to the first embodiment.

FIG. 7 is a diagram illustrating thrusts of a first piston and a second piston in a first state, a third state, and a second state.

FIG. 8 is a block diagram illustrating an example of controlling a pressure of the first piston and the second piston.

FIG. 9 is a flowchart illustrating an example of an ejection method for a material according to a second embodiment.

FIG. 10 is a cross-sectional view illustrating a configuration of an ejection device according to a third embodiment.

FIG. 11 is a cross-sectional view for describing an example of dimensions of a first space and a first communication path in the ejection device according to the third embodiment.

FIG. 12 is a cross-sectional view illustrating a configuration of an ejection device according to a fourth embodiment.

FIG. 13 is a cross-sectional view schematically illustrating an ejection device according to a fifth embodiment.

FIG. 14 is a cross-sectional view schematically illustrating an ejection device according to a variation of the fifth embodiment.

FIG. 15 is a cross-sectional view taken along the line XV-XV in FIG. 14.

FIG. 16 is a cross-sectional view schematically illustrating an ejection device according to a sixth embodiment.

FIG. 17 is a diagram schematically illustrating an example of an operation of the ejection device to eject a material according to a seventh embodiment.

### DESCRIPTION OF EMBODIMENTS

### First Embodiment

### Configuration of Molding Device 100

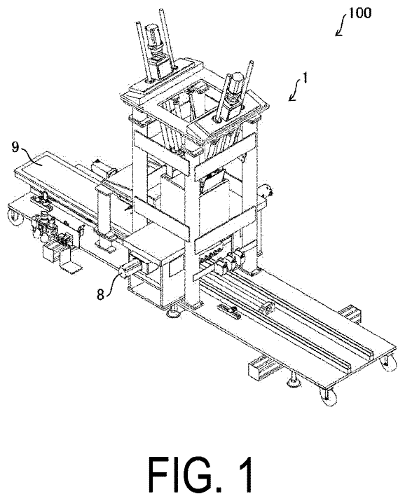

FIG. 1 is a perspective view illustrating a configuration of a molding device 100 according to a first embodiment. The molding device 100 molds a material containing a dispersion medium and a particulate dispersoid dispersed in the dispersion medium onto a base member. The material may be, for example, a mixture of ceramic particles and a solvent such as water in a ceramic material, or a mixture of an electrode active material and an organic solvent in a storage battery, but is not limited thereto. As illustrated in FIG. 1, the molding device 100 includes an ejection device 1 and a molding table 9.

The ejection device 1 ejects a material to be molded. In other words, the ejection device 1 is configured to be capable of ejecting a material to be molded. A specific configuration of the ejection device 1 will be described below. On the molding table 9, a base member is placed. The table on which the base member is placed may be made of a metal such as stainless steel or aluminum, or a ceramic material such as alumina. The molding table 9 is positioned below the ejection device 1. The molding table 9 is configured to be movable relative to the ejection device 1. The molding table 9 may be configured to be movable in the horizontal direction relative to the ejection device 1. Thus, the molding table 9 is movable relative to the ejection device 1 with the base member placed on the molding table 9. That is, the molding table 9 can move the base member relative to the ejection device 1. For example, the molding table 9 may be provided with a mechanism for moving the table by a rotary roller. Further, the molding table 9 may be provided with a mechanism for moving the base member adsorbed and placed directly on a belt conveyor without the table. The molding device 100 molds the material by ejecting the material from the ejection device 1 onto the base member, while moving the base member relative to the ejection device 1 by the molding table 9.

The molding device 100 may further include a height adjustment mechanism 8 for adjusting the height of the ejection device 1 relative to the base member. The height of the ejection device 1 relative to the base member is equivalent to the distance between the base member and the ejection device 1. In FIG. 1, the height adjustment mechanism 8 adjusts the height of the ejection device 1. However, the height adjustment mechanism 8 may adjust the height of the molding table 9. The height adjustment mechanism 8 adjusts the height of the ejection device 1 relative to the base member, so that the thickness of the material to be molded by the molding device 100 can be changed.

Instead of the molding table 9, the molding device 100 may include a feed roll for feeding the base member and a winding roll for winding up the base member. In this case, the molding device 100 molds the material by ejecting the material from the ejection device 1 onto the base member supplied in a so-called roll-to-roll manner.

### Configuration of Ejection Device 1

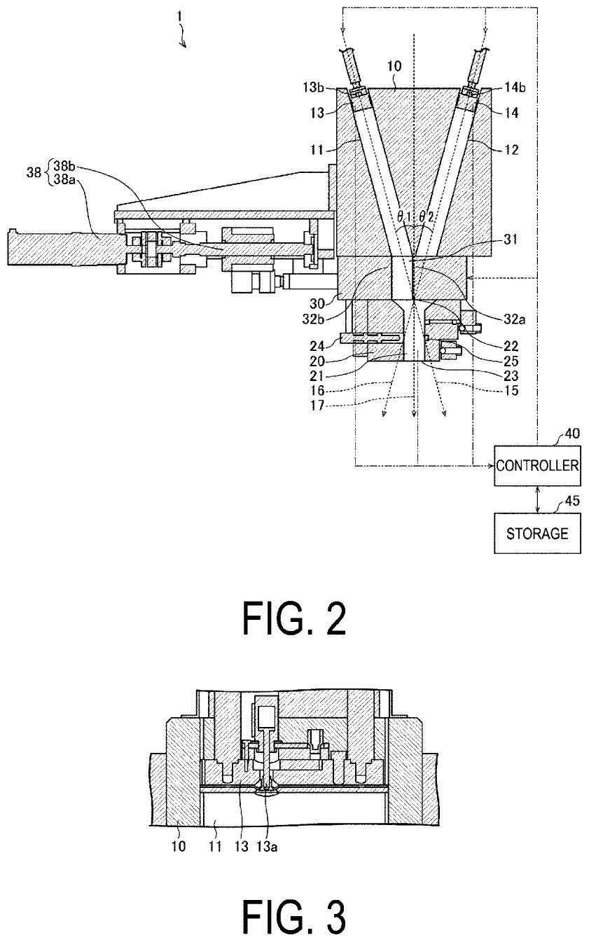

FIG. 2 is a cross-sectional view illustrating an example of the configuration of the ejection device 1. As illustrated in FIG. 2, the ejection device 1 includes a filling portion 10, an ejection portion 20, a switching portion 30, a controller 40, and a storage 45. In the ejection device 1, the material is ejected from the filling portion 10 through the switching portion 30 and the ejection portion 20 in this order.

The filling portion 10 is a housing in which the material is filled. In other words, the filling portion 10 is configured to be filled with the material. The shape of the filling portion 10 may be, for example, substantially cuboid, but is not limited thereto. The filling portion 10 includes a first space 11 and a second space 12 therein. The first space 11 and the second space 12 are filled with the material having fluidity.

The filling portion 10 further includes a first piston 13 and a second piston 14. The first piston 13 presses the material filled in the first space 11 by a pressing mechanism (not illustrated). In other words, the first piston 13 is configured to press the material filled in the first space 11. The first piston 13 may include a pressure gauge 13b for measuring the pressure of the material in contact with the first piston 13. The second piston 14 presses the material filled in the second space 12 by a pressing mechanism (not illustrated). In other words, the second piston 14 is configured to press the material filled in the second space 12. The second piston 14 may include a pressure gauge 14b for measuring the pressure of the material in contact with the second piston 14.

FIG. 3 is a cross-sectional view illustrating the structure of the first piston 13. Since the structure of the second piston 14 is the same as that of the first piston 13, illustration thereof is omitted.

As illustrated in FIG. 3, the first piston 13 may include an open-close valve 13a. The open-close valve 13a may be a one-way valve through which air can flow only to the outside from the first space 11. When the first space 11 is filled with the material, a vacuum pump (not illustrated) may evacuate the first space 11 through the open-close valve 13a before pressing the material with the first piston 13 inserted into the first space 11. In other words, the first piston 13 is configured to evacuate the first space 11 after the first space 11 is filled with material.

When the first space 11 is filled with the material, the material is filled from the end portion of the first space 11 with the first piston 13 pulled out from the first space 11, and then the first piston 13 is inserted into the first space 11. Thus, air may exist between the material and the first piston 13 at the time when the first piston 13 has been inserted. Additionally, air may exist in the material at the time when the first space 11 has been filled with material. By evacuating the first space 11, air between the material and the first piston 13 and air within the material can be removed. Thus, by pressing the material by the first piston 13 in this state, the ejection amount of the material is less likely to vary.

The ejection portion 20 is a mouthpiece that ejects the material. The ejection portion 20 includes an ejection path 21. The ejection path 21 is a flow path through which the material filled in the first space 11 and the second space 12 is ejected. In other words, the ejection portion 20 is configured to allow the material filled in the first space 11 and the second space 12 to be ejected from the ejection path 21.

The ejection path 21 includes a first end 22 and a second end 23. The first end 22 is an end portion facing the first space 11 or the second space 12. The second end 23 is an end portion opposite to the first end 22 and is open to the outside of the ejection device 1. In other words, the second end 23 has an opening to the outside of the ejection device 1. Specifically, the second end 23 may be opened toward the molding table 9.

Thus, the material filled in the first space 11 is pressed by the first piston 13 and ejected onto the base member on the molding table 9 through the ejection path 21. The material filled in the second space 12 is pressed by the second piston 14 and ejected onto the base member on the molding table 9 through the ejection path 21.

The ejection portion 20 may further include a resistance adjustment portion 24. The resistance adjustment portion 24 is a rod-shaped member that can project into the ejection path 21. The shape of the resistance adjustment portion 24 may be, for example, a cylinder or a square pole, but is not limited thereto. The resistance adjustment portion 24 may be moved by a drive mechanism (not illustrated) to a position where the resistance adjustment portion 24 projects into the ejection path 21 and a position where the resistance adjustment portion 24 does not project into the ejection path 21. In other words, the resistance adjustment portion 24 is configured to be movable between the position where the resistance adjustment portion 24 projects into the ejection path 21 and the position where the resistance adjustment portion 24 does not project into the ejection path 21. The controller 40 may output a control signal to the drive mechanism such that the resistance adjustment portion 24 is moved to either the position where the resistance adjustment portion 24 projects into the ejection path 21 or the position where the resistance adjustment portion 24 does not project into the ejection path 21.

When the resistance adjustment portion 24 is moved to a position where the resistance adjustment portion 24 projects into the ejection path 21, the resistance in the ejection path 21 against the flow of material is greater than when it is moved to a position where the resistance adjustment portion 24 does not project into the ejection path 21. Thus, by moving the position of the resistance adjustment portion 24, the magnitude of the resistance in the ejection path 21 against the flow of material can be adjusted.

The ejection portion 20 may further include a pressure gauge 25 for measuring the pressure of the material in the ejection portion 20.

In FIG. 2, an arrow 15 indicates the flow direction of the material in the first space 11. An arrow 16 indicates the flow direction of the material in the second space 12. An arrow 17 indicates the flow direction of the material in the ejection path 21. An angle formed by the arrow 15 and the arrow 17, that is, the angle formed by the flow direction of the material in the first space 11 and the flow direction of the material in the ejection path 21, is defined as θ1. An angle formed by the arrow 16 and the arrow 17, that is, the angle formed by the flow direction of the material in the second space 12 and the flow direction of the material in the ejection path 21, is defined as θ2. In this case, θ1 and θ2 may be 0° or more and 45° or less. The flow direction of the material in a communication path 31 may be the same as the flow direction of the material in the ejection path 21, for example.

When the angles θ1 and θ2 fall within this range, the material flows smoothly from the first space 11 and the second space 12 to the ejection path 21. Further, when (i) the angles θ1 and θ2 are greater than 0°, (ii) the filling portion 10 has a cuboid shape, and (iii) the flow direction of the material in the ejection path 21 is perpendicular to a plane of the cuboid filling portion 10 parallel to the horizontal plane, the length of the first space 11 and the second space 12 in the flow direction of the material is greater than when the angles θ1 and θ2 are 0°. Thus, the volume of the first space 11 and the second space 12 relative to the size of the filling portion 10, that is, the volume of the material that can be filled in the filling portion 10, can be increased compared to when the angles θ1 and θ2 are 0°.

The switching portion 30 is a casing having the communication path 31. Through the communication path 31, the first end 22 of the ejection path 21 may communicate with the first space 11, or the first end 22 of the ejection path 21 may communicate with the second space 12. In other words, the switching portion 30 is configured to allow the first end 22 of the ejection path 21 to communicate with the first space 11, or allow the first end 22 of the ejection path 21 to communicate with the second space 12 through the communication path 31.

The switching portion 30 can switch between a first state in which, through the communication path 31, the first end 22 of the ejection path 21 communicates with the first space 11, and a second state in which, through the communication path 31, the first end 22 of the ejection path 21 communicates with the second space 12. Specifically, the ejection device 1 may further include a switching portion drive mechanism 38. The switching portion drive mechanism 38 may include a motor 38a and a drive shaft 38b. Rotation of the motor 38a may be transmitted to the switching portion 30 via the drive shaft 38b to move the switching portion 30 relatively parallel to the filling portion 10.

The communication path 31 may communicate with the first space 11 or the second space 12 depending on the position of the switching portion 30 relative to the filling portion 10. Thus, the switching portion 30 can switch between the first state and the second state by moving relative to the filling portion 10 through the switching portion drive mechanism 38. When the switching portion 30 is in the first state, the ejection device 1 can eject material from the first space 11 through the communication path 31 and the ejection path 21. During this operation, the ejection device 1 can fill the material into the second space 12. When the switching portion 30 is in the second state, the ejection device 1 can eject material from the second space 12 through the communication path 31 and the ejection path 21. During this operation, the ejection device 1 can fill the material into the first space 11.

The switching portion 30 may further include a first blocking portion 32a and a second blocking portion 32b. The first blocking portion 32a may block the second space 12 from the outside in the first state. Additionally, the second blocking portion 32b may block the first space 11 from the outside in the second state. The term “outside” described herein refers to a side of the filling portion 10 facing the switching portion 30. In other words, the switching portion 30 is configured to block the second space 12 from the outside by the first blocking portion 32a, and block the first space 11 from the outside by the second blocking portion 32b.

Specifically, the first blocking portion 32a may be a surface of the switching portion 30 facing the second space 12 in the first state. The second blocking portion 32b may be a surface of the switching portion 30 facing the first space 11 in the second state. The switching portion 30 includes the first blocking portion 32a and the second blocking portion 32b, so that the likelihood of the material leaking from the first space 11 or the second space 12, which is not in communication with the ejection path 21, can be reduced.

In addition to the first and second states described above, the switching portion 30 may also switch to a third state in which, through the communication path 31, both of the first space 11 and second space 12 communicate with the ejection path 21. The ejection device 1 can eject the material from the first space 11 through the communication path 31 and the ejection path 21, and simultaneously eject the material from the second space 12 through the communication path 31 and the ejection path 21 when the switching portion 30 is in the third state.

The third state appears as a state in the process of switching from the first state to the second state, and from the second state to the first state. Since the switching portion 30 can also switch to the third state, the ejection device 1 can continuously eject the material from the ejection path 21 onto the base member on the molding table 9.

In the first, second, and third states, the sum of the volume per unit time of the material to be supplied from the first space 11 to the communication path 31, and the volume per unit time of the material to be supplied from the second space 12 to the communication path 31 may be constant. The sum of these volumes is constant, which enables the volume per unit time of the material to be supplied to the ejection path 21 to be constant, regardless of whether the switching portion 30 is in the first, second, or third state. Furthermore, the volume per unit time of the material to be ejected from the ejection device 1 onto the base member on the molding table 9 can be constant.

The term “constant” described herein does not necessarily mean to be completely constant. That is, the volume per unit time of the material to be supplied to the ejection path 21 may vary within a range where the volume can be regarded as being substantially constant. For example, assuming that the lower limit of the variation in the volume per unit time of the material to be supplied to the ejection path 21 is 95% or more of the upper limit, this volume can be regarded as being substantially constant.

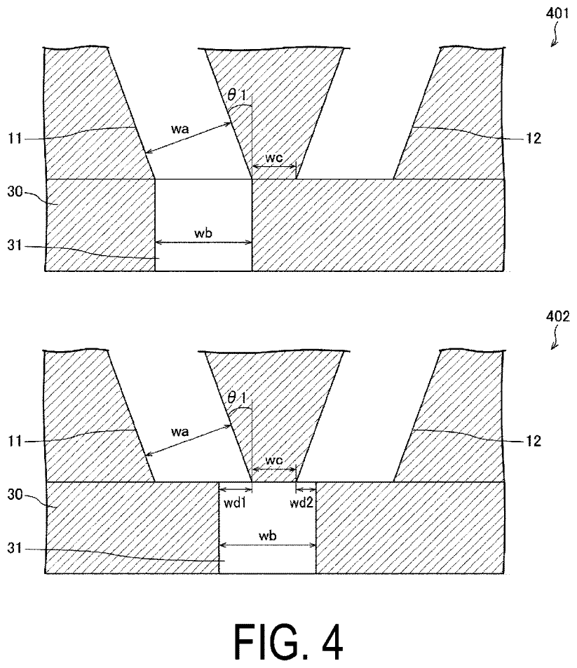

FIG. 4 is a cross-sectional view for describing an example of the dimensions of the first space 11 and the communication path 31 in the ejection device 1. In FIG. 4, the first space 11 and the communication path 31 are assumed to have a cylindrical shape having an axis parallel to the drawing plane. In FIG. 4, a reference sign 401 denotes a first state, and a reference sign 402 denotes a second state.

As indicated by the reference sign 401, the lateral width of the first space 11 with respect to the material flow direction is denoted by wa. The length of the communication path 31 in the direction parallel to the boundary between the filling portion 10 and the switching portion 30 is denoted by wb. An angle formed by the flow direction of the material in the first space 11 and the flow direction of the material in the communication path 31 is denoted by θ1 described above. In this case, wa and wb may satisfy Equation (1) below.

$$wb \times cos ( θ 1 ) = wa \qquad ( 1 )$$

When Equation (1) is satisfied, the dimension of the first space 11 coincides with the dimension of the communication path 31 at the boundary between the first space 11 and the communication path 31.

The width of a portion of the surface of the filling portion 10 facing the switching portion 30, where this portion is interposed between the first space 11 and the second space 12, is wc. At this time, wb and wc may satisfy Equation (2) below.

$$wb > wc \qquad ( 2 )$$

When Equation (2) is satisfied, the third state appears as a state in the process of switching from the first state to the second state, and from the second state to the first state. The value of wc may be as close to 0 as possible within a range where a strength sufficient to withstand the pressure of the material can be ensured.

As indicated by the reference sign 402, the width of a region of the switching portion 30 in the third state, where the first space 11 and the communication path 31 communicate with each other, is defined as wd1. The width of a region of the switching portion 30 in the third state, where the second space 12 and the communication path 31 communicate with each other, is defined as wd2. Since the value of we cannot be 0, the sum of wd 1 and wd2 is smaller than wb.

In the third state, the pressure applied to the material by the first piston 13 and the second piston 14 may be increased as compared with the first and second states. As a result, the flow rate of the material increases, which enables the volume per unit time of the material to be supplied to the ejection path 21 to be constant.

The controller 40 controls the operation of the ejection device 1. For example, the controller 40 outputs a control signal to press the material to the pressing mechanism of the first piston 13 and the second piston 14. The controller 40 also outputs a control signal to move the switching portion 30 to the switching portion drive mechanism 38. For this control, the controller 40 may receive signals input from the pressure gauges 13b, 14b, and 25 and indicating the pressures at their respective locations. In other words, the controller 40 may be configured to control the first piston 13, the second piston 14, and the switching portion drive mechanism 38 based on the signals from the pressure gauges 13b, 14b, and 25.

The switching portion drive mechanism 38 may include a servo motor that is controlled by the controller 40. The controller 40 may recognize the position of the switching portion 30 based on the output signal from the servo motor. Furthermore, the controller 40 may recognize whether the switching portion 30 is in the first state, the second state, or the third state based on the position of the switching portion.

The pressing mechanism for pressing the material by each of the first piston 13 and the second piston 14 may include a servo motor that is controlled by the controller 40. The controller 40 may recognize each position of the first piston 13 and the second piston 14 based on the output signal from the servo motor. Furthermore, the controller 40 may recognize the volume of material filled in the first space 11 based on the position of the first piston 13, and the volume of material filled in the second space 12 based on the position of the second piston 14.

However, one or more of the switching portion drive mechanism 38 and the pressing mechanisms for pressing the material by the first piston 13 and the second piston 14, may not include a servo motor. For example, when the switching portion drive mechanism 38 does not include a servo motor, the switching portion 30 may include a position sensor for outputting a signal indicating the position of the switching portion 30. When the pressing mechanism for pressing the material by the first piston 13 does not include a servo motor, the first piston 13 may include a position sensor for outputting a signal indicating the position of the first piston 13. When the pressing mechanism for pressing the material by the second piston 14 does not include a servo motor, the second piston 14 may include a position sensor for outputting a signal indicating the position of the second piston 14.

The storage 45 stores information necessary for the controller 40 to control the operation of the ejection device 1. However, the ejection device 1 does not necessarily include the storage 45, and the controller 40 may be communicably connected to an external storage that stores information necessary for the controller 40 to control the operation of the ejection device 1. The information stored in the storage 45 may be input by known input means such as a keyboard or a touch panel provided separately.

### Operation of Ejection Device 1

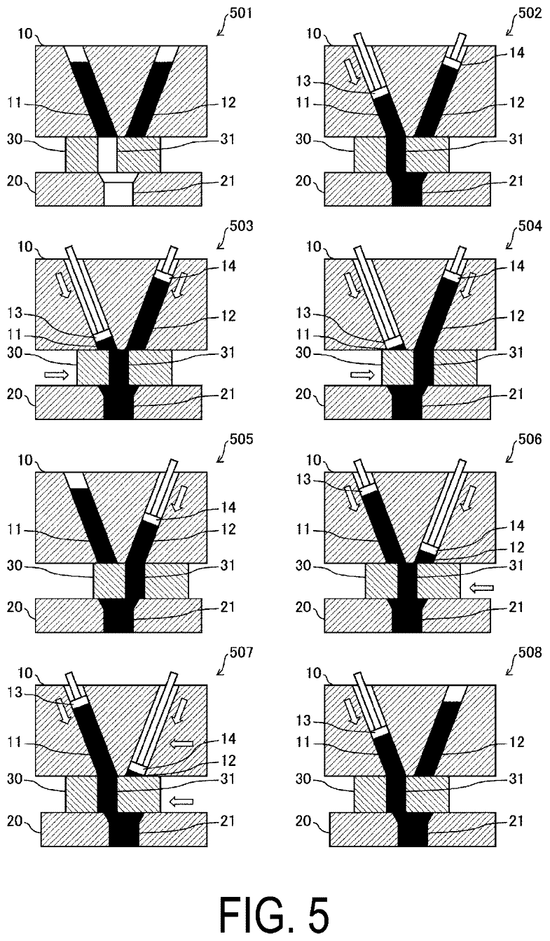

FIG. 5 is a diagram illustrating an example of an operation of the ejection device 1 to eject the material. In an initial state of the ejection device 1, each of the first space 11 and the second space 12 may be filled with the material, as illustrated by a reference sign 501. In the example illustrated in FIG. 5, the initial state of the switching portion 30 is the first state. However, in the operation of the ejection device 1, the initial state of the switching portion 30 may be the second state.

When the ejection device 1 starts ejecting the material, the controller 40 may cause the first piston 13 to press the material filled in the first space 11, as illustrated by a reference sign 502. The material pressed by the first piston 13 is ejected from the first space 11 through the communication path 31 and the ejection path 21.

When the amount of the material filled in the first space 11 decreases (that is, the first piston 13 approaches the switching portion 30 in the first space 11), the controller 40 may moves the switching portion 30 parallel to the filling portion 10, as illustrated by a reference sign 503. The controller 40 recognizes that the switching portion 30 has shifted from the first state to the third state based on the position of the switching portion 30.

When the switching portion 30 is in the third state shifted from the first state, the controller 40 may cause the first piston 13 to continuously press the material filled in the first space 11. Furthermore, when the switching portion 30 is in the third state shifted from the first state, the controller 40 may cause the second piston 14 to press the material filled in the second space 12. The material pressed by the second piston 14 is ejected from the second space 12 through the communication path 31 and the ejection path 21. This reduces molding defects of the material ejected from the ejection portion 20, which are caused by a small amount of material left in the first space 11.

Before all of the material filled in the first space 11 is ejected (that is, before the first piston 13 moves to the end portion of the first space 11 facing the switching portion 30), the controller 40 may move the switching portion 30 parallel to the filling portion 10 as illustrated by a reference sign 504. Based on the position of the switching portion 30, the controller 40 recognizes that the switching portion 30 has shifted from the third state to the second state.

When the switching portion 30 is in the second state, the controller 40 may cause the second piston 14 to continuously press the material filled in the second space 12 after the third state. When the switching portion 30 is in the second state, the first space 11 may be filled with the material as illustrated by a reference sign 505.

After the first space 11 is filled with the material, when the amount of material in the second space 12 decreases (that is, when the second piston 14 approaches the switching portion 30 in the second space 12), the controller 40 may move the switching portion 30 parallel to the filling portion 10 as illustrated by a reference sign 506. The controller 40 recognizes that the switching portion 30 has shifted from the second state to the third state based on the position of the switching portion 30.

When the switching portion 30 is in the third state shifted from the second state, the controller 40 may cause the second piston 14 to continuously press the material filled in the second space 12. When the switching portion 30 is in the third state shifted from the second state, the controller 40 may cause the first piston 13 to press the material filled in the first space 11. The material pressed by the first piston 13 is ejected from the first space 11 through the communication path 31 and the ejection path 21. This reduces molding defects of the material ejected from the ejection portion 20, which are caused by a small amount of material left in the second space 12.

Before all of the material filled in the second space 12 is ejected (that is, before the second piston 14 moves to the end portion of the second space 12 facing the switching portion 30), the controller 40 may move the switching portion 30 parallel to the filling portion 10 as illustrated by a reference sign 507. The controller 40 recognizes that the switching portion 30 has shifted from the third state to the first state based on the position of the switching portion 30.

When the switching portion 30 is in the first state, the first piston 13 may continuously press the material filled in the first space 11 after the third state. Additionally, when the switching portion 30 is in the first state, the second space 12 may be filled with material as illustrated by a reference sign 508.

After the material is filled in the second space 12, when the amount of material into the first space 11 decreases, the controller 40 may move the switching portion 30 parallel to the filling portion 10 as illustrated by the reference sign 503. Thereafter, the ejection device 1 can continuously eject the material from the ejection path 21 to the outside by repeating the operations described with reference to the reference signs 503 to 508.

In the above description, the ejection portion 20 does not move relative to the filling portion 10, and only the switching portion 30 moves relative to the filling portion 10. However, the ejection portion 20 may move together with the switching portion 30 relative to the filling portion 10.

The material may be filled into the first space 11 and the second space 12 manually or by a device for filling the material. When the material is filled into the first space 11 and the second space 12 by a device that fills the material, the ejection device 1 may include the device. The device that fills the material may be a separate device from the ejection device 1.

### Flowchart of Ejection Method

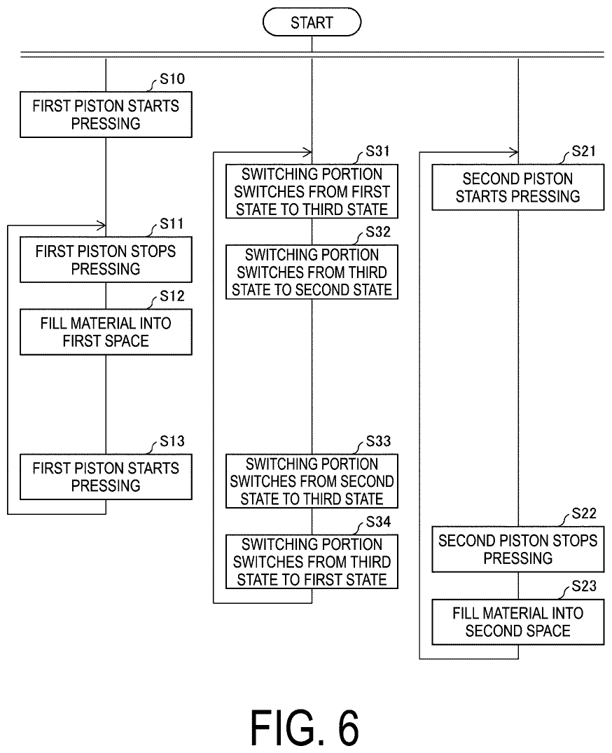

FIG. 6 is a flowchart illustrating an example of an ejection method for the material by the ejection device 1. An example of the operation of the ejection device 1 is described with reference to the flowchart as follows. In the following description, the material is filled into the first space 11 and the second space 12 by a device that is controlled by the controller 40. In the initial state of the ejection device 1, both the first space 11 and the second space 12 are filled with the material, as indicated by the reference sign 501 in FIG. 5.

First, the controller 40 causes the first piston 13 to start pressing the material filled in the first space 11 (S10). Thus, the controller 40 extrudes the material filled in the first space 11 out of the first space 11 (first extrusion step). In response to a displacement of the first piston 13, that is, a decrease in the volume of the material filled in the first space 11, the controller 40 switches from the first state to the third state by moving the switching portion 30 parallel to the filling portion 10 (S31). The controller 40 also causes the second piston 14 to start pressing the material filled in the second space 12 (S21). As a result, the controller 40 extrudes the material filled in the second space 12 out of the second space 12 (second extrusion step).

In response to a further displacement of the first piston 13, that is, a further decrease in the volume of the material filled in the first space 11, the controller 40 switches from the third state to the second state by moving the switching portion 30 parallel to the filling portion 10 (S32). When the ejection device 1 switches to the second state, the controller 40 causes the first piston 13 to stop pressing the material filled in the first space 11 (S11). On the other hand, the controller 40 causes the second piston 14 to continuously press the material filled in the second space 12. In this state, the controller 40 fills the first space 11 with the material (S12). Specifically, the controller 40 causes the first piston 13 to be pulled out from the first space 11 to fill the first space 11 with the material, and then causes the first piston 13 to be inserted into the first space 11.

After the end of step S12, in response to a displacement of the second piston 14, that is, a decrease in the volume of the material filled in the second space 12, the controller 40 switches from the second state to the third state by moving the switching portion 30 parallel to the filling portion 10 (S33). The controller 40 also causes the first piston 13 to start pressing the material filled in the first space 11 (S13). Thus, the controller 40 extrudes the material filled in the first space 11 out of the first space 11 (first extrusion step).

In response to a further displacement of the second piston 14, that is, a further decrease in the volume of the material filled in the second space 12, the controller 40 switches from the third state to the first state by moving the switching portion 30 parallel to the filling portion 10 (S34). When the ejection device 1 switches to the first state, the controller 40 causes the second piston 14 to stop pressing the material filled in the second space 12 (S22). On the other hand, the controller 40 causes the first piston 13 to continuously press the material filled in the first space 11. In this state, the controller 40 fills the second space 12 with the material (S23). Specifically, the controller 40 pulls out the second piston 14 from the second space 12 to fill the second space 12 with the material, and then inserts the second piston 14 into the second space 12.

Thereafter, the controller 40 repeats the processes in steps S11 to S13 in relation to the first space 11 and the first piston 13. The controller 40 also repeats the processes in steps S21 to S23 in relation to the second space 12 and the second piston 14. The controller 40 also repeats the processes in steps S31 to S34 in relation to the switching portion 30. Thus, the ejection device 1 can continuously eject the material from the ejection portion 20 in any of the first state, the second state, or the third state.

In the above flow, when steps S31 and S32 are combined, the controller 40 is regarded as switching the switching portion 30 from the first state to the second state. When steps S33 and S34 are combined, the controller 40 is regarded as switching the switching portion 30 from the second state to the first state. Thus, steps S31 to S34 can be collectively referred to as a switching step of switching the switching portion 30 between the first state and the second state. Further, in the above flow, the controller 40 can be described as executing at least a portion of the switching step in parallel with the first extrusion step (S10 and S13) or the second extrusion step (S21).

### Thrust of First Piston 13 and Second Piston 14

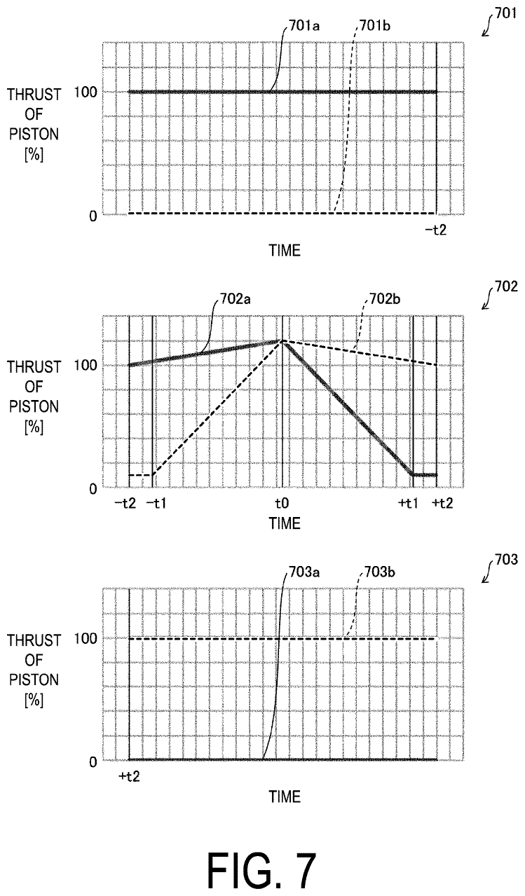

FIG. 7 is a diagram illustrating thrusts of the first piston 13 and the second piston 14 in each of the first, third, and second states. The thrust is a force applied to each of the first piston 13 and the second piston 14 by the pressing mechanism to press the material.

In FIG. 7, a reference sign 701 is a graph illustrating thrusts of the first piston 13 and the second piston 14 in the first state. A reference sign 702 is a graph illustrating thrusts of the first piston 13 and the second piston 14 in the third state. A reference sign 703 is a graph illustrating thrusts of the first piston 13 and the second piston 14 in the second state. In each graph, the horizontal axis represents time, and the vertical axis represents a thrust of the first piston 13 and the second piston 14.

In the third state, the time illustrated on the horizontal axis, at which the area of the region where the first space 11 and the communication path 31 communicate with each other is equal to the area of the region where the second space 12 and the communication path 31 communicate with each other, is defined as t0. The time at which the switching portion 30 starts moving is defined as t2. The time at which the switching portion 30 ends moving is defined as +t2. Further, after the time −t2, the time at which the communication path 31 shifts from a state of communicating with only the first space 11 to a state of communicating with both the first space 11 and the second space 12 is defined as −t1. Before the time +t2, the time at which the communication path 31 shifts from a state of communicating with both the first space 11 and the second space 12 to a state of communicating with only the second space 12 is defined as +t1.

In FIG. 7, the relationship between the time and the state of the switching portion 30 is as follows.
Before the time −t2, the switching portion 30 is in the first state.
From the time −t2 to time +t2, the switching portion 30 is in the third state. During the period from time −t2 to time +t2, the switching portion 30 moves from the first space 11 to the second space 12 parallel to the filling portion 10 at a constant speed.
After the time +t2, the switching portion 30 is in the second state.

As illustrated on the vertical axis, the thrust of the first piston 13 is represented as a percentage relative to the thrust of the first piston 13 in the first state set at 100%, while the thrust of the second piston 14 is represented as a percentage relative to the thrust of the second piston 14 in the second state set at 100%. Since the magnitude of thrust is determined by the controller 40, the controller 40 can recognize the thrust.

In the graph denoted by the reference sign 701, a graph 701a indicates the thrust of the first piston 13 and a graph 701b indicates the thrust of the second piston 14. In the first state, the thrust of the first piston 13 may always be 100% and the thrust of the second piston 14 may always be 0%.

In the graph denoted by the reference sign 702, a graph 702a indicates the thrust of the first piston 13. A graph 702b indicates the thrust of the second piston 14.

When the switching portion 30 starts moving at the time −t2, the thrust of the first piston 13 may be 100%. As the time is closer to the time to from the time −t2, the thrust of the first piston 13 slowly rises from 100% and may rise to, for example, 120% at the time to.

As the time is closer to the time +t1 from the time to, the thrust of the first piston 13 may rapidly drop from 120%. At the time +t1, when the first space 11 no longer communicates with the communication path 31, the thrust of the first piston 13 may be slightly higher than 0%, for example, 10%. From the time +t1 to time +t2, the thrust of the first piston 13 may be a constant value slightly higher than 0%.

When the switching portion 30 starts moving at the time −t2, the thrust of the second piston 14 may be slightly higher than 0%, for example, 10%. That is, the second piston 14 may start pressing the material filled in the second space 12 before the second space 12 starts communicating with the communication path 31. From the time −t2 to the time −t1 at which the second space 12 starts communicating with the communication path 31, the thrust of the second piston 14 may be a constant value slightly higher than 0%.

After the second space 12 starts communicating with the communication path 31 at the time −t1, the thrust of the second piston 14 increases rapidly as the time is closer to the time to, and may increase to, for example, 120% at the time to. After the time to, as the time is closer to the time +t2, the thrust of the second piston 14 decreases slowly and may decrease to 100% at the time +t2.

As described above, in the third state, the sum of the width of the region where the first space 11 communicates with the communication path 31 and the width of the region where the second space 12 communicates with the communication path 31 is smaller than the width of the region of the switching portion 30 in the first state, where the first space 11 communicates with the communication path 31. In the third state, the thrust of one or both of the first piston 13 and the second piston 14 is set larger than 100% to increase the flow rate of the material. As a result, the volume per unit time of the material to be supplied to the ejection path 21 can be constant between the third state and the first state, or between the third state and the second state.

In the third state, not only each of the first space 11 and the second space 12 communicates with the ejection path 21 through the communication path 31, but also the first space 11 and the second space 12 communicate with each other through the communication path 31. During the period from the time −t2 to time −t1, the backflow of the material from the communication path 31 to the second space 12 can be reduced by setting the thrust of the second piston 14 greater than 0%. During the period from the time +t1 to time +t2, the backflow of material from the communication path 31 to the first space 11 can be reduced by setting the thrust of the first piston 13 greater than 0%. The distance through which the switching portion 30 moves during the period from the time −t2 to time −t1, and the distance through which the switching portion 30 moves during the period from the time +t1 to time +t2 may be 10% or less, or 5% or less of the distance through which the switching portion 30 moves during the period from the time −t2 to time +t2.

In the graph denoted by the reference sign 703, a graph 703a illustrates the relationship between the position of the switching portion 30 and the thrust of the first piston 13, and a graph 703b illustrates the relationship between the position of the switching portion 30 and the thrust of the second piston 14. In the second state, regardless of the position of the switching portion 30, the thrust of the first piston 13 may be 0% and the thrust of the second piston 14 may be 100%.

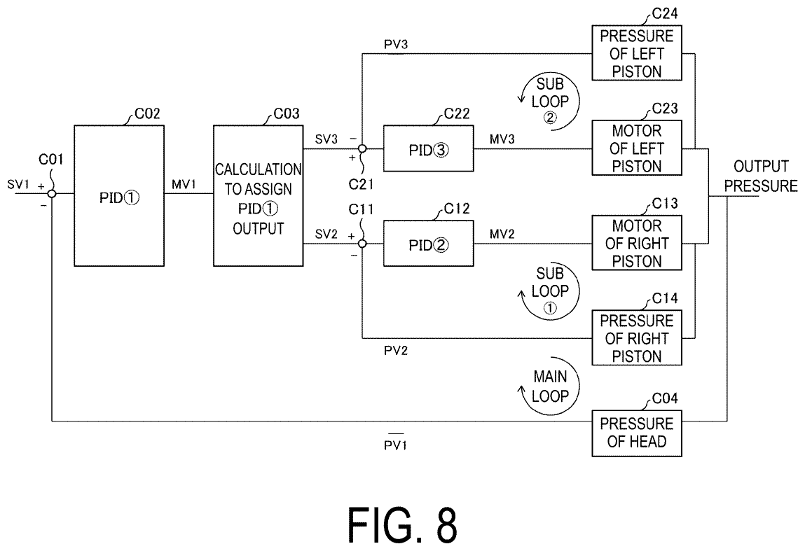

FIG. 8 is a block diagram illustrating an example of control of the thrust of the first piston 13 and the second piston 14. As illustrated in FIG. 8, the controller 40 may control the thrust of the first piston 13 and the second piston 14 by so-called cascade control.

The controller 40 calculates a deviation (C01) between a target value SV1 of the material pressure in the ejection portion 20 and an actual material pressure PV1 in the ejection portion 20, and performs a first proportional integral differential (PID) operation to derive a first control signal MV1 (C02). In the first PID operation, the following proportional term, integral term, and differential term are calculated, and the sum of these terms is defined as MV1.
Proportional term: a result of multiplication of the deviation between SV1 and PV1 by a proportional gain
Integral term: a result of multiplication of an integral value of the deviation between SV1 and PV1 by an integral gain
Differential term: a result of multiplication of a differential value of the deviation between SV1 and PV1 by a differential gain

The proportional gain, integral gain, and differential gain may be appropriately determined by a user according to the state of the material, the target pressure, and the movement speed of the base member moved by the molding table 9.

The controller 40 converts the first control signal MV1 into the target value of the material pressure in the first piston 13 and the second piston 14. Specifically, the controller 40 multiplies MV1 by SV1. Since the value of MV1 ranges from −250% to 250%, the target pressure ranges from a value −2.5 times larger than SV1 to a value 2.5 times larger than SV1. Further, the controller 40 determines a target value SV2 of the material pressure in the first piston 13 and a target value SV3 of the material pressure in the second piston 14 according to the converted target values of the material pressure, and the position of the switching portion 30 (C03).

The controller 40 calculates a deviation between the target value SV2 of the material pressure in the first piston 13 and an actual material pressure PV2 in the first piston 13 (C11), and performs a second PID operation to derive a second control signal MV2 (C12). In the second PID operation, the following proportional term, integral term, and differential term are calculated, and the sum of these terms is defined as MV2.
Proportional term: a result of multiplication of a deviation between SV2 and PV2 by a proportional gain
Integral term: a result of multiplication of an integral value of the deviation between SV2 and PV2 by an integral gain
Differential term: a result of multiplication of a differential value of the deviation between SV2 and PV2 by a differential gain

The proportional gain, integral gain, and differential gain may be appropriately determined by a user according to the state of the material, the target pressure, and the movement speed of the base member moved by the molding table 9.

Further, the controller 40 derives a control signal for controlling the thrust of the first piston 13 by multiplying the second control signal MV2 by the maximum rotational speed of the motor in the pressing device of the first piston 13 (C13). Since the value of MV2 ranges from −100% to 100%, the controller 40 controls the thrust of the first piston 13 by controlling the rotational speed of the motor to fall within a range from −1 times higher than the maximum rotational speed to 1 time lower than the maximum rotational speed.

The controller 40 calculates a deviation between the target value SV3 of the material pressure in the second piston 14 and an actual material pressure PV3 in the second piston 14 (C21), and performs a third PID operation to derive a third control signal MV3 (C22). In the third PID operation, the following proportional term, integral term and differential term are calculated, and the sum of these terms is defined as MV3.
Proportional term: a result of multiplication of a deviation between SV3 and PV3 by a proportional gain
Integral term: a result of multiplication of an integral value of the deviation between SV3 and PV3 by an integral gain
Differential term: a result of multiplication of a differential value of the deviation between SV3 and PV3 by a differential gain

The proportional gain, integral gain, and differential gain may be appropriately determined by a user according to the state of the material, the target pressure, and the movement speed of the base member moved by the molding table 9.

Further, the controller 40 derives a control signal for controlling the thrust of the second piston 14 by multiplying the third control signal MV3 by the rotational speed of the motor in the pressing device of the second piston 14 (C23). Since the value of MV3 ranges from −100% to 100%, the controller 40 controls the thrust of the second piston 14 by controlling the rotational speed of the motor to fall within a range from −1 times higher than the maximum rotational speed to 1 time lower than the maximum rotational speed.

The controller 40 may acquire a signal indicating the material pressure in the first piston 13 after controlling the thrust of the first piston 13. The controller 40 may use the acquired signal as the material pressure PV2 in the first piston 13 to be subtracted from the target value SV2 of the pressure in the first piston 13 at C11 in the next control (C14). The controller 40 also acquires a signal indicating the material pressure in the second piston 14 after controlling the thrust of the second piston 14. The controller 40 may use the acquired signal as the material pressure PV3 in the second piston 14 to be subtracted from the target value SV3 of the pressure in the second piston 14 at C21 in the next control (C24). The controller 40 may acquire a signal indicating the material pressure in the ejection portion 20 after controlling the thrust of the first piston 13 and the second piston 14. The controller 40 may use the acquired signal as the actual material pressure PV1 in the ejection portion 20 to be subtracted from the target value SV1 of the material pressure in the ejection portion 20 at C01 in the next control. By executing the control described above, the thrusts of the first piston 13 and the second piston 14 can be controlled as illustrated in FIG. 7.

However, in the first state, the controller 40 may assign the target value converted from the first control signal MV1 directly as the target value SV2 of the pressure in the first piston 13. In this case, the controller 40 does not perform the control at C21 to C24. In the second state, the controller 40 may assign the target value converted from the first control signal MV1 directly as the target value SV3 of the pressure in the second piston 14. In this case, the controller 40 does not perform the processing at C11 to C14.

As described above, the ejection device 1 can continuously eject material from the ejection portion 20 in each of the first state, the second state, and the third state. Thus, the time efficiency in ejecting the material can be improved. In addition, the molding device 100 molds the material continuously ejected from the ejection device 1 and can thus improve the time efficiency in the molding.

### Second Embodiment

Other embodiments of the present disclosure will be described below. For convenience of description, members having the same functions as those described in the above embodiments will be denoted by the same reference signs, and the description will not be repeated.

In the first embodiment, the ejection device 1 operates to eject material from the ejection portion 20 in any of the first, second, or third state. However, the ejection device 1 does not necessarily eject material from the ejection portion 20 in the third state, and may eject material from the ejection portion 20 only in the first and second states. In other words, the controller 40 may be configured to control the first piston 13, the second piston 14, and the switching portion drive mechanism 38 so as to eject material from the ejection portion 20 only in the first and second states.

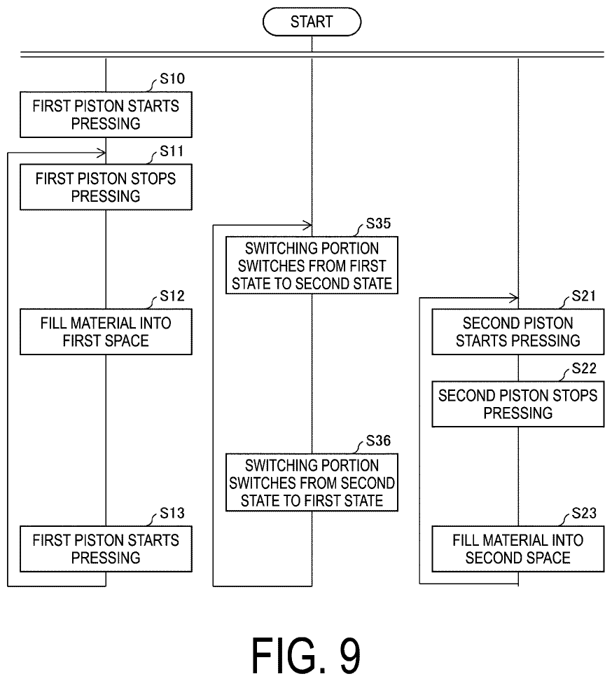

FIG. 9 is a flowchart illustrating an example of a material ejection method according to a second embodiment. In an example of the ejection method according to the second embodiment, initially, the controller 40 causes the first piston 13 to start pressing the material filled in the first space 11 (S10, first extrusion step). In response to a decrease of the amount of material filled in the first space 11, that is, a displacement of the first piston 13, the controller 40 causes the first piston 13 to stop pressing the material filled in the first space 11 (S11). The controller 40 does not need to control anything other than the first piston 13 from step S10 to step S11.

After step S11, the controller 40 switches the switching portion 30 from the first state to the second state (S35, switching step). After the switching portion 30 enters the second state, the controller 40 causes the second piston 14 to start pressing the material filled in the second space 12 (S21, second extrusion step). The controller 40 also fills the first space 11 with the material in parallel with step S21 (S12). In response to a decrease in the amount of material filled in the second space 12, that is, a displacement of the second piston 14, the controller 40 causes the second piston 14 to stop pressing the material filled in the second space 12 (S22).

After step S22, the controller 40 switches the switching portion 30 from the second state to the first state (S36, switching step). After the switching portion 30 enters the first state, the controller 40 causes the first piston 13 to start pressing the material filled in the first space 11 (S13, first extrusion step). The controller 40 fills the second space 12 with the material in parallel with step S13 (S23).

Thereafter, the controller 40 repeats the processes in steps S11 to S13 in relation to the first space 11 and the first piston 13. The controller 40 also repeats the processes in steps S21 to S23 in relation to the second space 12 and the second piston 14. The controller 40 also repeats the processes in steps S35 and S36 in relation to the switching portion 30. Thus, the ejection device 1 can eject the material from the ejection portion 20 in the first state and the second state. Consequently, the time efficiency in ejecting the material can be improved compared with repeatedly filling and ejecting the material using only the first space 11, for example.

### Third Embodiment

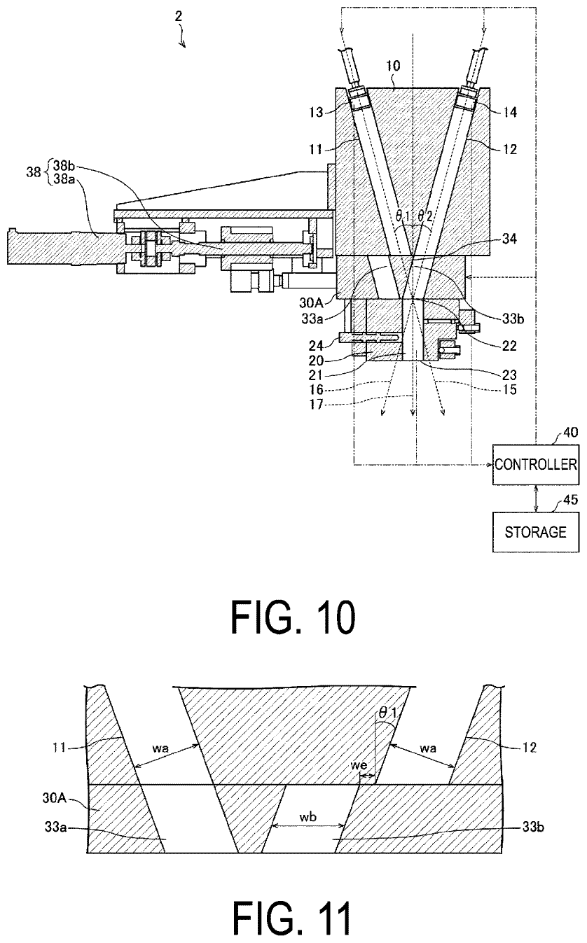

FIG. 10 is a cross-sectional view illustrating the configuration of an ejection device 2 according to a third embodiment. As illustrated in FIG. 10, the ejection device 2 differs from the ejection device 1 in that the ejection device 2 includes a switching portion 30A instead of the switching portion 30. The switching portion 30A differs from the switching portion 30 in that the switching portion 30A includes a first communication path 33a (communication path) and a second communication path 33b (communication path) instead of the communication path 31, and also includes a blocking portion 34 instead of the first blocking portion 32a and the second blocking portion 32b.

The first communication path 33a may be a communication path through which the first end 22 of the ejection path 21 communicates with the first space 11. The second communication path 33b may be a communication path through which the first end 22 of the ejection path 21 communicates with the second space 12. In the ejection device 2, in the first state, through the first communication path 33a, the first end 22 of the ejection path 21 may communicate with the first space 11. In the second state, through the second communication path 33b, the first end 22 of the ejection path 21 may communicate with the second space 12. In the third state, through the first communication path 33a, the first end 22 of the ejection path 21 may communicate with the first space 11, and through the second communication path 33b, the first end 22 of the ejection path 21 may communicate with the second space 12. In other words, the switching portion 30A is configured to allow the first end 22 of the ejection path 21 to communicate with the first space 11 through the first communication path 33a, and allow the first end 22 of the ejection path 21 to communicate with the second space 12 through the second communication path 33b.

The blocking portion 34 may be located between the first communication path 33a and the second communication path 33b. The blocking portion 34 may function as a first blocking portion that faces the second space 12 in the first state and blocks the second space 12 from the outside. The blocking portion 34 may function as a second blocking portion that faces the first space 11 in the second state and blocks the first space 11 from the outside. The configuration of the blocking portion 34 may be the same as that of the first blocking portion 32a and the second blocking portion 32b. In other words, the switching portion 30A is configured to block the second space 12 or the first space 11 from the outside by the blocking portion 34 depending on the state of the switching portion 30A.

In the ejection device 2, an angle θ1 (angle formed between the flow direction of the material in the first space 11 and the flow direction of material in the ejection path 21) and an angle θ2 (angle formed between the flow direction of the material in the second space 12 and the flow direction of the material in the ejection path 21) may be 0° or more and 45° or less. The flow direction of the material in the first communication path 33a may be the same as the flow direction of the material in the first space 11, for example. The flow direction of the material in the second communication path 33b may be the same as the flow direction of the material in the second space 12, for example. In addition, the flow direction of the material in the first communication path 33a and the flow direction of the material in the second communication path 33b may both be the same as the flow direction of the material in the ejection path 21.

Furthermore, the flow direction of the material in the first communication path 33a may be between the flow direction of the material in the first space 11 and the flow direction of the material in the ejection path 21. The flow direction of the material in the second communication path 33b may be between the flow direction of the material in the second space 12 and the flow direction of the material in the ejection path 21. That is, the angle formed by the flow direction of the material in the first communication path 33a and the flow direction of the material in the ejection path 21 may be greater than 0° and less than θ1. The angle formed by the flow direction of the material in the second communication path 33b and the flow direction of the material in the ejection path 21 may be greater than 0° and less than θ2.

FIG. 11 is a cross-sectional view for describing an example of the dimensions of the first space 11 and the first communication path 33a in the ejection device 2. In FIG. 11, the switching portion 30A is in the first state.

The distance between the second communication path 33b and the second space 12 at the boundary between the filling portion 10 and the switching portion 30A of the ejection device 2 in the first state is defined as we. At this time, wb and we may satisfy Equation (3) below.

$$wb > we \qquad ( 3 )$$

When Equation (3) is satisfied, the third state appears in the ejection device 2 as a state in the process of switching from the first state to the second state, and from the second state to the first state.

Unlike wc in the ejection device 1, the value of we in the ejection device 2 can be set to 0. However, from the viewpoint of reducing the possibility that the second space 12 and the second communication path 33b communicate with each other in the first state, and reducing the possibility that the first space 11 and the first communication path 33a communicate with each other in the second state, the value of we may be set greater than 0.

As described above, the switching portion 30A can switch to the first state, the second state, or the third state in the ejection device 2. The ejection device 2 can eject the material when the switching portion 30A is in each of the first state to the third state (see the first embodiment) or when the switching portion 30A is in each of the first state and the second state (see the second embodiment). Thus, the time efficiency in ejecting the material can be improved.

### Fourth Embodiment

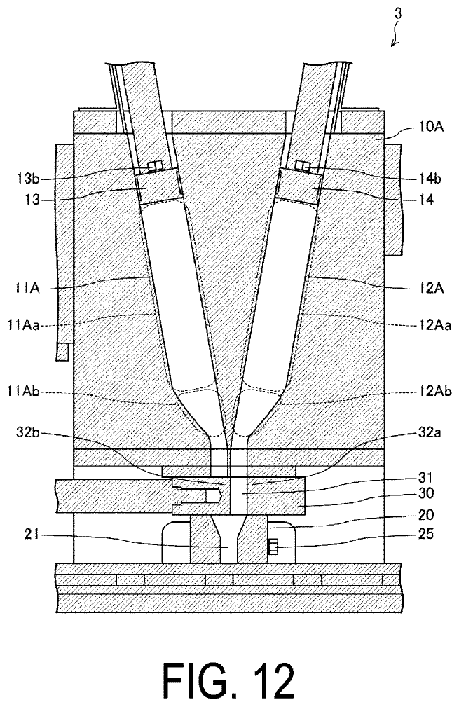

FIG. 12 is a cross-sectional view illustrating the configuration of an ejection device 3 according to a fourth embodiment. As illustrated in FIG. 12, the ejection device 3 differs from the ejection device 1 in that the ejection device 3 includes a filling portion 10A instead of the filling portion 10. The filling portion 10A differs from the filling portion 10 in that the filling portion 10A includes a first space 11A instead of the first space 11, and also includes a second space 12A instead of the second space 12.

As illustrated in FIG. 12, the first space 11A includes an enlarged-diameter portion 11Aa and a reduced-diameter portion 11Ab. In the flow of the material in the first space 11A, the enlarged-diameter portion 11Aa is located upstream of the reduced-diameter portion 11Ab. The enlarged-diameter portion 11Aa and the reduced-diameter portion 11Ab are different in diameter from each other. The diameter of the enlarged-diameter portion 11Aa is larger than the diameter of the reduced-diameter portion 11Ab.

The second space 12A includes an enlarged-diameter portion 12Aa and a reduced-diameter portion 12Ab. In the flow of the material in the second space 12A, the enlarged-diameter portion 12Aa is located upstream of the reduced-diameter portion 12Ab. The enlarged-diameter portion 12Aa and the reduced diameter portion 12Ab are different in diameter from each other. The diameter of the enlarged-diameter portion 12Aa is larger than the diameter of the reduced-diameter portion 12Ab.

In the ejection device 3, the diameters of the reduced-diameter portions 11Ab and 12Ab facing the communication path 31 can be matched with the diameter of the communication path 31. In addition, the first space 11A includes the enlarged-diameter portion 12Aa, and the second space 12A includes the enlarged-diameter portion 12Aa, so that a larger amount of material can be filled in the first and second spaces 11A and 12A than when not including these enlarged-diameter portions. Thus, when a constant volume of material is ejected, the number of times of material filling can be reduced, and the material can be ejected more efficiently.

### Fifth Embodiment

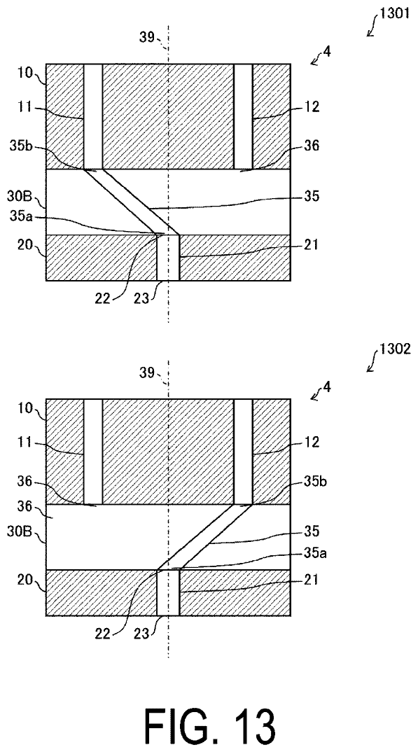

FIG. 13 is a cross-sectional view schematically illustrating an ejection device 4 according to a fifth embodiment. As illustrated in FIG. 13, the ejection device 4 differs from the ejection device 1 in that the ejection device 4 includes a switching portion 30B instead of the switching portion 30. The switching portion 30B differs from the switching portion 30 in that the switching portion 30B includes a communication path 35 instead of the communication path 31, and also includes a blocking portion 36 instead of the first blocking portion 32a and the second blocking portion 32b. The switching portion 30B may be rotatable about a rotation axis 39 coincident with the central axis of the ejection path 21.

Through the communication path 35, the first end 22 of the ejection path 21 may communicate with the first space 11, or the first end 22 of the ejection path 21 may communicate with the second space 12. The communication path 35 may include a first end 35a that is an end portion facing the ejection path 21, and a second end 35b that is an end portion facing the first space 11 and second space 12. The first end 35a may be located on the rotation axis 39. The second end 35b may be located away from the rotation axis 39. Thus, the switching portion 30B rotates about the rotation axis 39, and can therefore displace the second end 35b without displacing the first end 35a. As a result, the switching portion 30B can switch between the first state in which the end portion communicates with the first space 11, and the second state in which the end portion communicates with the second space 12. In other words, the switching portion 30B is configured to be switchable between the first state and the second state by rotating about the rotation axis 39.

The blocking portion 36 may be an area passing through the end portion of the communication path 35 facing the ejection path 21, other than the end portion of the communication path 35 facing the ejection path 21 on the circumference about the rotation axis 39. The blocking portion 36 may function as a first blocking portion for blocking the second space 12 from the outside in the first state. The blocking portion 36 may function as a second blocking portion for blocking the first space 11 from the outside in the second state.

The ejection device 4 having the above configuration can also eject the material from the ejection portion 20 in each of the first state and the second state (see the second embodiment). Thus, the time efficiency in ejecting the material can be improved.

### Variation

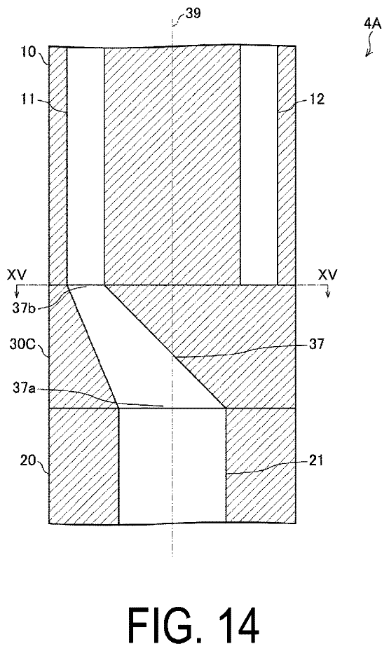

FIG. 14 is a cross-sectional view schematically illustrating an ejection device 4A according to a variation of the fifth embodiment. As illustrated in FIG. 14, the ejection device 4A differs from the ejection device 4 in that the ejection device 4A includes a switching portion 30C instead of a switching portion 30B. The switching portion 30C differs from the switching portion 30B in that the switching portion 30C includes a communication path 37 instead of the communication path 35. The switching portion 30C may be rotatable about the rotation axis 39 coincident with the central axis of the ejection path 21.

The communication path 37 may include a first end 37a facing the ejection path 21 and a second end 37b facing the first space 11 and second space 12. The first end 37a may be located on the rotation axis 39. On the other hand, the second end 37b may be arc-shaped about the rotation axis 39. Further, in the ejection device 4A, the first space 11 and the second space 12 may also be arc-shaped about the rotation axis 39. The second end 37b, the first space 11, and the second space 12 have the above-described shapes, so that the switching portion 30C can switch to the third state in which both the first space 11 and the second space 12 communicate with the ejection path 21. The central angles of the arcs of the second end 37b, the first space 11, and the second space 12 may be, for example, 170° or more and less than 180°.

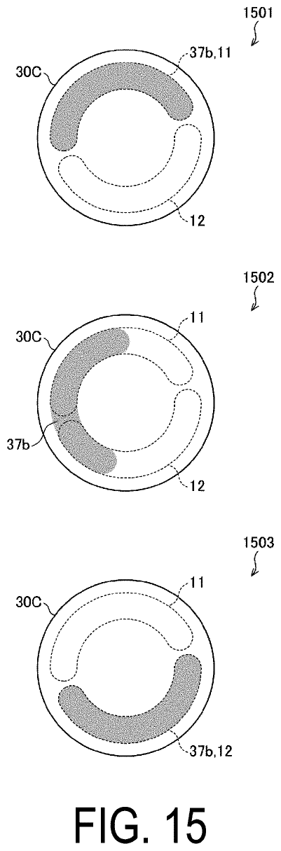

FIG. 15 is a cross-sectional view taken along the line XV-XV in FIG. 14. In FIG. 15, a reference sign 1501 denotes a first state. A reference sign 1502 denotes a third state. A reference sign 1503 denotes a second state. FIG. 15 illustrates not only the second end 37b of the communication path 37, but also the first space 11 and the second space 12.

As indicated by the reference sign 1501, in the first state, the arc-shaped second end 37b overlaps the circular arc shaped first space 11. As indicated by the reference sign 1502, in the third state, the arc-shaped second end 37b overlaps a portion of the arc-shaped first space 11 and a portion of the arc-shaped second space 12. As indicated by the reference sign 1503, in the second state, the arc-shaped second end 37b overlaps the arc-shaped second space 12.

As described above, in the ejection device 4A, the switching portion 30C that rotates about the rotation axis 39 switches between the first state, the second state, and the third state. In other words, the switching portion 30C is configured to be switchable between the first state, the second state, and the third state by rotating about the rotation axis 39. The time efficiency in ejecting material can also be improved by the ejection device 4A.

### Sixth Embodiment

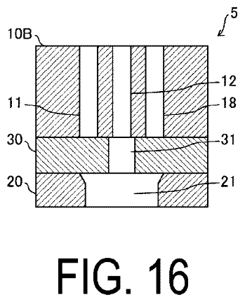

FIG. 16 is a cross-sectional view schematically illustrating an ejection device 5 according to a sixth embodiment. As illustrated in FIG. 16, the ejection device 5 differs from the ejection device 1 in that the ejection device 5 includes a filling portion 10B instead of the filling portion 10. The filling portion 10B differs from the filling portion 10 in that the filling portion 10B further includes a third space 18 in addition to the first space 11 and the second space 12.

Also in the ejection device 5, the switching portion 30 can switch between the first, second, and third states described above. In the ejection device 5, the switching portion 30 can switch between (i) a state in which, through the communication path 31, the first end 22 of the ejection path 21 communicates with the third space 18, and (ii) a state in which, through the communication path 31, both the second space 12 and the third space 18 communicate with the ejection path 21.

In the ejection device 5 described above, when the switching portion 30 is in each of the states described above, the material can be ejected through the ejection path 21 from any of the first space 11, the second space 12, and the third space 18, which communicates with the ejection path 21. The material can be filled in any of the first space 11, the second space 12, and the third space 18, which does not communicate with the ejection path 21. Thus, the material can be continuously ejected, and the time efficiency in ejecting the material can be improved. Furthermore, the filling portion in the ejection device according to the present disclosure may include, in addition to the first space 11, the second space 12, and the third space 18, still another space in which the material can be filled.

### Seventh Embodiment

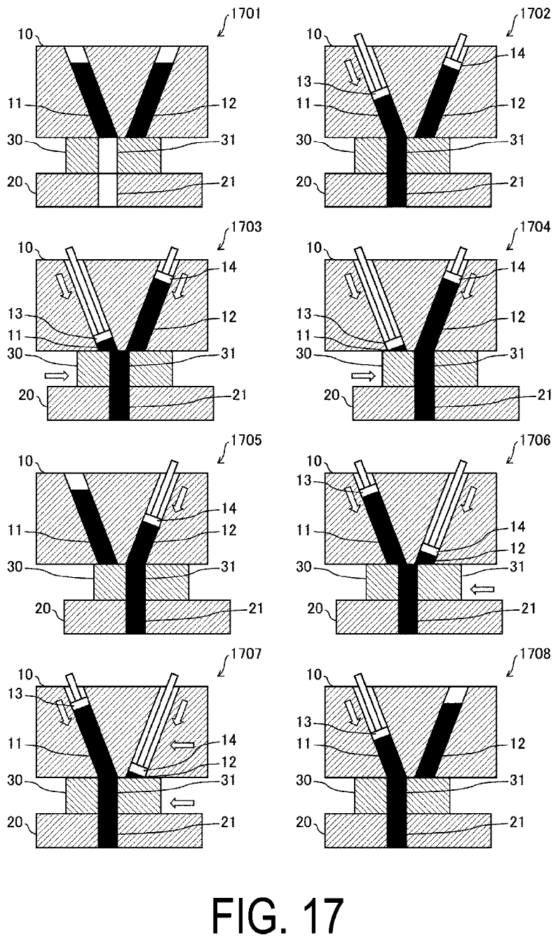

FIG. 17 is a diagram illustrating an example of the operation of the ejection device 1 to eject the material according to a seventh embodiment. In FIG. 17, reference signs 1701 to 1708 indicate states corresponding to the reference signs 501 to 508 in FIG. 5, respectively.

In the first embodiment, as illustrated in FIG. 5, the position of the ejection portion 20 is fixed relative to the filling portion 10, and only the switching portion 30 is moved relative to the filling portion 10. In the seventh embodiment, the ejection portion 20 may move relative to the filling portion 10 integrally with the switching portion 30. Even with such an ejection method, the time efficiency in ejecting the material can be improved.

In the first embodiment, the first end 22 (see FIG. 2) of the ejection path 21 has a shape that widens toward the switching portion 30 in order to accommodate the movement of the switching portion 30. However, in the seventh embodiment, since the ejection portion 20 moves integrally with the switching portion 30, the first end 22 of the ejection path 21 does not need to have a shape that widens toward the switching portion 30.

The invention according to the present disclosure has been described above based on the drawings and examples. However, the invention according to the present disclosure is not limited to the above-described embodiments. That is, the embodiments of the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, it should be noted that a person skilled in the art can easily make different variations or modifications based on the present disclosure. It should also be noted that these variations or modifications are within the scope of the present disclosure.

### REFERENCE SIGNS

1, 2, 3, 4, 4A, 5 Ejection device
9 Molding table
10, 10A Filling portion
11, 11A First space
12, 12A Second space
20 Ejection portion
21 Ejection path
22 First end
23 Second end
30, 30A, 30B, 30C Switching portion
31, 35, 37 Communication path
32a First blocking portion
32b Second blocking portion
33a First communication path (Communication path)
33b Second communication path (Communication path)
34, 36 Blocking portion (First blocking portion, Second blocking portion)
100 Molding device

1. An ejection device comprising:
a filling portion comprising a first space and a second space, wherein the first space and the second space are filled with a material having a dispersion medium and a particulate dispersoid dispersed in the dispersion medium;
an ejection portion comprising an ejection path, wherein the ejection path comprises a first end and a second end, the first end communicates with the first space or the second space, and the second end is open to outside; and
a switching portion comprising at least one communication path through which the first end of the ejection path communicates with the first space or the second space, wherein the switching portion switches between a first state where, through the at least one communication path, the first space communicates with the ejection path, and a second state where, through the at least one communication path, the second space communicates with the ejection path.

2. The ejection device according to claim 1, wherein
the switching portion switches between the first state and the second state by moving relative to the filling portion.

3. The ejection device according to claim 2, wherein
the ejection portion moves integrally with the switching portion relative to the filling portion.

4. The ejection device according to claim 1, wherein
an angle formed by a flow direction of the material in the first space and a flow direction of the material in the ejection path, and
an angle formed by a flow direction of the material in the second space and a flow direction of the material in the ejection path
are 0° or more, and 45° or less.

5. The ejection device according to claim 1, wherein
the switching portion further comprises:
a first blocking portion configured to block the second space in the first state; and
a second blocking portion configured to block the first space in the second state.

6. The ejection device according to claim 1, wherein
the switching portion switches between:
the first state;
the second state; and
a third state where, through which the at least one communication path, both the first space and the second space communicate with the ejection path.

7. The ejection device according to claim 6, wherein
in the first state, the second state, and the third state, a sum of (i) a volume per unit time of the material to be supplied from the first space to the communication path, and (ii) a volume per unit time of the material to be supplied from the second space to the communication path, is constant.

8. A molding device comprising:
the ejection device according to claim 1; and
a molding table on which a base member is placed to eject the material onto the base member from the ejection device.

9. An ejection method for a material using an ejection device,
the ejection device comprising:
a filling portion comprising a first space and a second space, wherein the first space and the second space are filled with the material having a dispersion medium and a particulate dispersoid dispersed in the dispersion medium;
an ejection portion comprising an ejection path, wherein the ejection path comprises a first end and a second end, the first end communicates with the first space or the second space, and the second end is open to outside; and
a switching portion comprising at least one communication path through which the first end of the ejection path communicates with the first space or the second space, wherein the switching portion switches between a first state where, through the at least one communication path, the first space communicates with the ejection path, and a second state where, through the at least one communication path, the second space communicates with the ejection path,
the ejection method comprising:
a first extrusion step of extruding the material filled in the first space out of the first space;
a second extrusion step of extruding the material filled in the second space out of the second space; and
a switching step of switching the switching portion between the first state and the second state.
